(19) United States
(12) Patent Application Publication
(10) Pub. No.: US 2012/0117261 A1
(43) Pub. Date: May 10, 2012

(54) Method and Apparatus for Rate Adaptation for Adaptive HTTP Streaming

(75) Inventor: Imed Bouazizi, Tampere (FI)

(73) Assignee: NOKIA CORPORATION, Espoo (FI)

(21) Appl. No.: 12/940,998

(22) Filed: Nov. 5, 2010

(51) Int. Cl. G06F 15/16

(52) U.S. Cl. 709/231

(57) ABSTRACT

A method comprises performing one or more checks associated with hyper text transport protocol streaming of segmented media data, the segmented media data being streamed at a current bandwidth level corresponding to current representation of the content; deciding, based on the results of the one or more checks, whether or not to switch to another representation associated with another bandwidth level different from said current bandwidth level; and upon deciding to switch to another representation, selecting a new representation with a bandwidth level different from said current bandwidth level; and requesting a next media segment from the new representation.

### TECHNICAL FIELD

The present application relates generally to streaming data and, more particularly, to streaming via Hyper Text Transport Protocol (HTTP).

### BACKGROUND

Traditionally, Transmission Control Protocol (TCP) has been recognized as having drawbacks when used for the delivery of real-time media, such as audio and video content. The drawbacks of TCP relate, for example, to the aggressive congestion control algorithm and the retransmission procedure that TCP implements. In TCP transmissions, the sender reduces the transmission rate upon recognition of a congestion event through, for example, packet loss or excessive transmission delays. The transmission throughput of TCP may behave like a saw-tooth shape. The TCP protocol tolerates delivery delays in favor of reliable and congestion-aware transmission. In contrast, streaming applications are delay sensitive.

### SUMMARY

Various aspects of examples of the invention are set out in the claims.

According to a first aspect of the present invention, a method comprises performing one or more checks associated with hyper text transport protocol streaming of segmented media data, the segmented media data being streamed at a current bandwidth level corresponding to current representation of the content; deciding, based on the results of the one or more checks, whether or not to switch to another representation associated with another bandwidth level different from said current bandwidth level; and upon deciding to switch to another representation, selecting a new representation with a bandwidth level different from said current bandwidth level; and requesting a next media segment from the new representation.

According to a second aspect of the present invention, an apparatus comprises at least one processor; and at least one memory including computer program code, the at least one memory and the computer program code configured to, with the at least one processor, cause the apparatus to perform at least the following: perform one or more checks associated with hyper text transport protocol streaming of segmented media data, the segmented media data being streamed at a current bandwidth level corresponding to current representation of the content; decide, based on the results of the one or more checks, whether or not to switch to another representation associated with another bandwidth level different from said current bandwidth level; and upon deciding to switch to another representation, select a new representation with a bandwidth level different from said current bandwidth level; and request a next media segment from the new representation.

According to a third aspect of the present invention, a computer-readable medium including computer executable instructions which, when executed by a processor, cause an apparatus to perform at least the following: perform one or more checks associated with hyper text transport protocol streaming of segmented media data, the segmented media data being streamed at a current bandwidth level corresponding to current representation of the content; decide, based on the results of the one or more checks, whether or not to switch to another representation associated with another bandwidth level different from said current bandwidth level; and upon deciding to switch to another representation, select a new representation with a bandwidth level different from said current bandwidth level; and request a next media segment from the new representation.

According to a fourth aspect of the present invention, an apparatus comprises means for performing one or more checks associated with hyper text transport protocol streaming of segmented media data, the segmented media data being streamed at a current bandwidth level corresponding to current representation of the content; means for deciding, based on the results of the one or more checks, whether or not to switch to another representation associated with another bandwidth level different from said current bandwidth level; and means for, upon deciding to switch to another representation, selecting a new representation with a bandwidth level different from said current bandwidth level; and requesting a next media segment from the new representation.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example adaptive HTTP streaming architecture;

FIG. 2 illustrates an example structure of a Media Presentatino Description (MPD) file;

FIG. 3 illustrates an example of an ISO base media file format;

FIG. 4 is a flow chart illustrating a process of selecting the bandwidth level and the corresponding representation from which the next media segment is to be requested, in accordance with an example embodiment of the current invention;

FIG. 5 is a flow chart illustrating a process of determining the idle time between successive media segment requests, in accordance with an example embodiment of the current invention;

FIG. 6 is an overview diagram of a system within which various embodiments may be implemented; and

FIG. 7 is a schematic representation of the circuitry which may be included in an exemplary electronic device which may be utilized in accordance with the various embodiments.

### DETAILED DESCRIPTION OF THE DRAWINGS

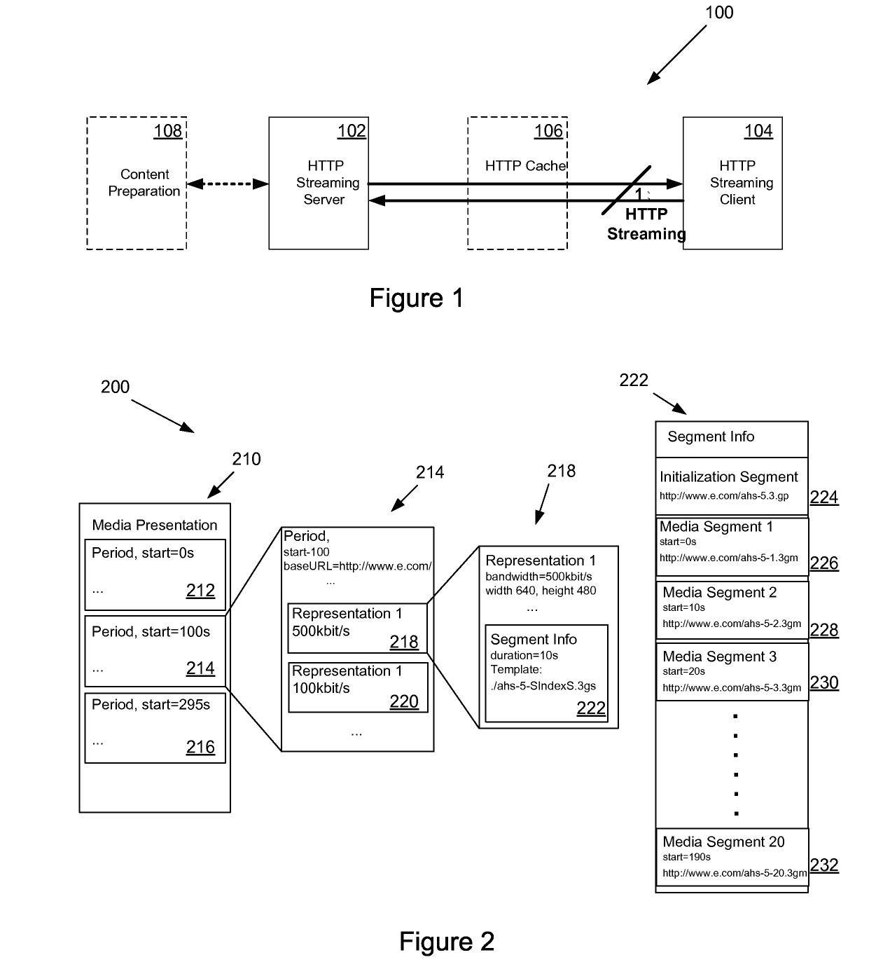

Example embodiments of the present invention and their potential advantages are understood by referring to FIGS. 1-7 of the drawings.

The transmission control protocol (TCP) has drawbacks when used for delivery of real-time media. Recently, the trend has shifted towards the deployment of the Hyper Text Transport Protocol (HTTP) as the preferred protocol for the delivery of multimedia content over the Internet. HTTP runs on top of TCP and is a textual protocol. This shift may be attributable to the ease of deployment of HTTP. There is no need to deploy a dedicated server for delivering the content. Further, HTTP is typically granted access through firewalls and NATs, which singnificantly simplifies the deployment.

An Adaptive HTTP Streaming (AHS) solution has been standardized recently by the 3rd Generation Partnership Project (3GPP), and the same solution has been adopted by several other standardization bodies, such as MPEG and OIPF.

Referring now to FIG. 1, an example of the AHS architecture is illustrated. In AHS, an HTTP content server 102 streams content to one or more streaming clients, such as HTTP streaming client 104. The media content may be streamed directly to the HTTP clients from the HTTP content server 102. Alternatively an intermediate web cache, or HTTP cache 106, may be used for temporarily storing media content. The streaming client 104 may be any of a variety of devices, such as a mobile handset, a laptop, a personal computer (PC), a tablet device, a set-up box, a personal digital assistant (PDA) device, a media player or other communication device.

In AHS, a content preparation step is performed. The content preparation step may be performed by a separate entity, such as content preparation module 108 illustrated in FIG. 1, or by the HTTP streaming server 102. Through the content preparation step, the content is segmented into multiple segments. An initialization segment is created to carry the information necessary to configure the media player to allow the streaming client 104 to consume the media.

The content is typically encoded in multiple bitrates. Each encoding corresponds to a representation of the content. The content representations may be alternatives to each other. For example, the client may select only one alternative out of the group of alternative representations. In other embodiments, the content representations may complement each other. The client may elect to add complementary representations that contain additional media components, for example.

The content offered for AHS is described to the client using a Media Presentation Description (MPD) file. FIG. 2 illustrates an example structure of a MPD file. The MPD is a XML file that contains a description of the content, the periods of the content, e.g., 214 in FIG. 2, the representations of the content, e.g., 218 in FIG. 2, and, most importantly, how to access each piece of the content. A MPD element 210 is the main element in the MPD file 200. It contains general information about the content, such as its type and the time window during which the content is available. The MPD contains one or more periods 212, 214, 216, each of which describes a time segment of the content. Each Period may contain one or more representations of the content. As illustrated in FIG. 2, Period 214 contains at least two representations 218, 220. Each representation is an encoding of the content with a different configuration. Representations may differ in various respects, such as bandwidth requirements, the media components they contain, the codecs in use, or languages, for example.

Each representation includes information which enables the streaming client to consume the content. For example, as illustrated in FIG. 2, the representation 218 contains segment information 222 including an initialization segment 224, and one or more media segments 226-232. In the illustrated embodiment, each media segment 226-232 has a start time for the media of that particular segment and references a location for the content.

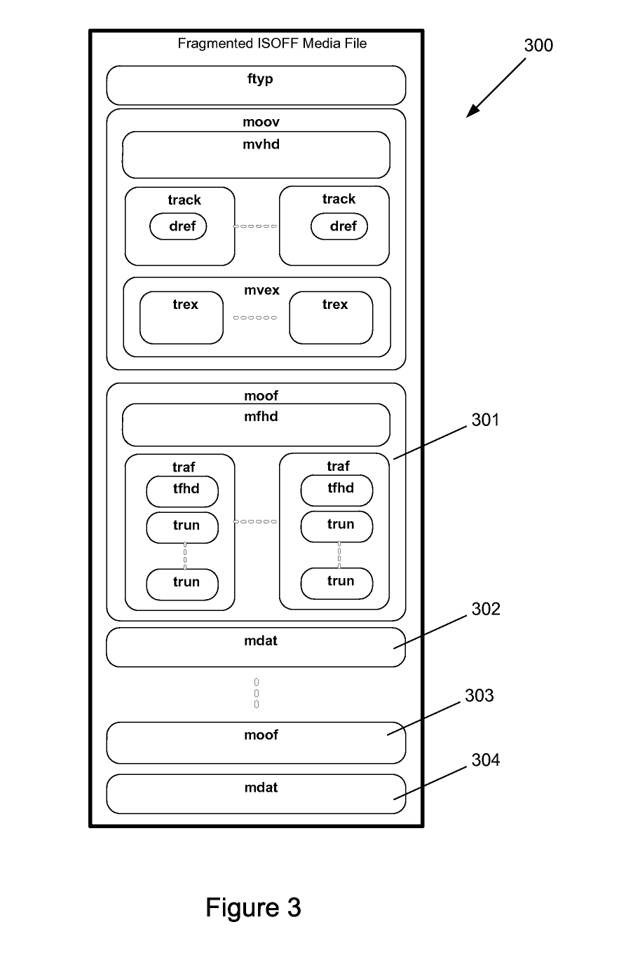

In one embodiment, AHS may use the ISO-base File Format and its derivates, e.g., the MP4 and the 3GPP file formats, are used. FIG. 3 illustrates an example of an ISO base media file format for use with AHS. The content is stored in so-called movie fragments. Each movie fragment contains the media data 302, 304 and the corresponding meta data 301, 303. The media data 302, 304 is typically a collection of media samples from all media components of the representation. Each media component is described as a track of the file.

In embodiments of AHS, the client is responsible for the media session. The client, e.g., communication client or playback device, attempts to ensure smooth playback, avoiding playback interruptions as much as possible. At the same time, the client must ensure good user experience by reducing the buffering delays. This represents a trade-off for the client, as smooth interruption-free playback is typically achieved through long initial buffering.

Embodiments of the present invention provide for rate adaptation in AHS sessions at the client. The rate adaptation algorithms decide on switching actions between content representations and/or determine the idle time between consecutive media segment requests.

In accordance with embodiments, a rate adaptation algorithm may be based on:
a) a media segment fetch time to media segment duration ratio (FTDR); and
b) the amount of currently buffered media (BT).

The media segment fetch time in the FTDR is a measure of the amount of time it takes the client to fetch a segment. Further, the media segment duration in the FTDR is a measure of the length of playback time for the media data of that segment.

In certain embodiments of the present invention, the content configuration information, e.g., as provided by the MPD, is used. Information about the available and suitable set of representations as well as their respective bandwidth requirements is extracted.

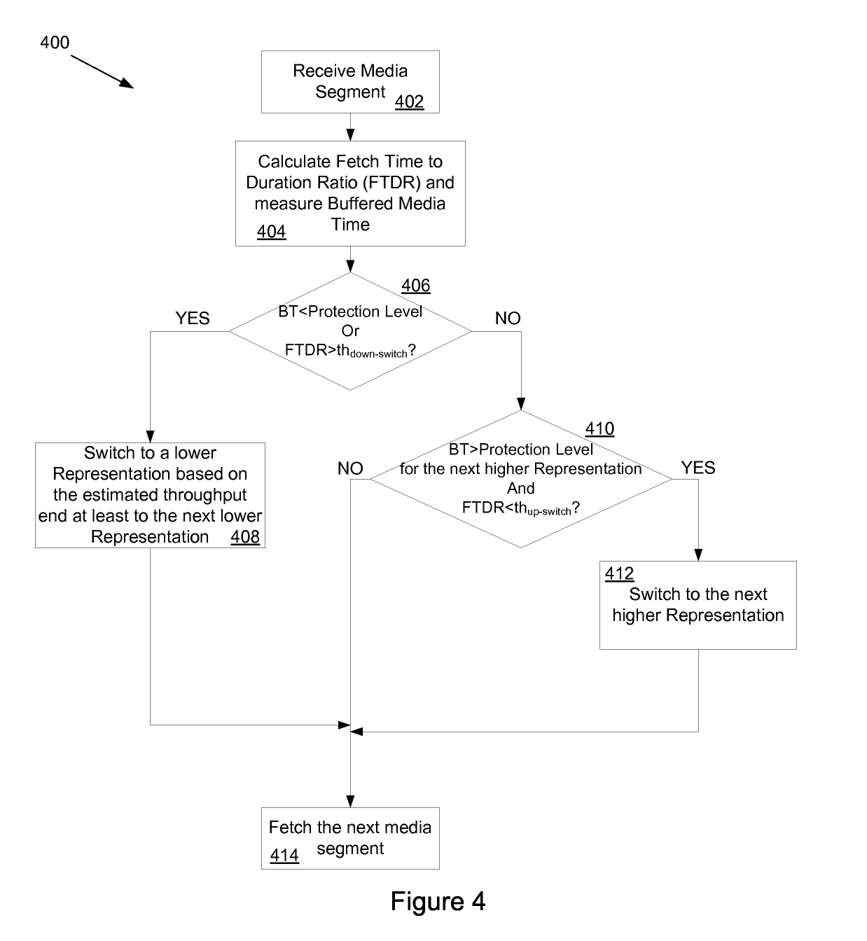

Referring now to FIG. 4, a flow chart illustrates a process 400 in accordance with an example embodiment of rate adaptation for use with AHS. In accordance with the method illustrated in FIG. 4, media segments are received by the client device at block 402. In accordance with an example embodiment, the streaming session preferably starts with a representation that requires a bandwidth lower than the currently available bandwidth. In a particular embodiment, the client may start with the representation, or combination of representations, that requires the least bandwidth. By doing this, the required amount of buffered media data indicated by the minBufferTime may be reached very fast, and the media playback can start as soon as possible. Further, it is possible that the media segment will be fetched in an amount of time that is shorter than or equal to the playback duration of the segment. Alternatively, the streaming session may start with a representation that requires a bandwidth close to the currently available bandwidth.

At block 404, the client calculates the FTDR and BT in order to determine whether a change to a representation with a bandwidth level different from the current bandwidth level is needed. The current bandwidth level is the bandwidth level of the current representation. In accordance with an example embodiment, the client updates the FTDR and BT metrics and evaluates the need to perform a representation change after completing the reception of a media segment. In certain embodiments, additional updates and evaluations may be performed more frequently.

In one embodiment, the FTDR and BT metrics are calculated or updated as follows:

$$F T D R = \frac{Segment Fetch Duration}{{SD}_{current}}$$

$${BT}_{i} = max ( 0 , {BT}_{i - 1} + {SD}_{current} - {MP}_{i - 1 , i} )$$

where:

SD_{current} is the media segment playback duration for the current representation,

BTᵢ is the playback duration of buffered media after fetching segment i,

BTᵢ₋₁ is the playback duration of buffered media after fetching segment i−1, and

MP_{i-1,i} is the amount of media that has been played back in the period of time between fetching segment i−1 and fetching segment i.

Note that MP_{i-1,i} is equal to the time elapsed between receiving the last byte from segment i and receiving the last byte from segment i−1 in case the client is not in buffering state.

In other embodiments, the FTDR may be calculated as an n-term moving average or weighted moving average. In particular, this might be the case when segment duration is too short to be indicative of the actual throughput.

Upon updating the above metrics, the client runs a decision algorithm to decide whether or not there is a need for switching to a representation with a higher bandwidth level or switching to a representation with a lower bandwidth level.

At block 406, the process performs two checks. The first check determines whether the BT metric is less than a protection level, e.g., a buffer threshold associated with the current representation. The protection level, or the buffer threshold, may be either a preset value or may be determined by the client in real time based on various conditions. In one embodiment, the protection level is a threshold value of the currently buffered media time, defined as th_{minbuffer}. If the buffered media time, BT, is lower than the threshold, then a switch to a representation with a lower bandwidth level is performed.

The second check at block 406 is a check of the FTDR. In this regard, the FTDR is compared against a threshold th_{switchdown} value. In one embodiment, the threshold is set as follows:

th_{switchdown}=1+ε

where ε is used in order to provide tolerance against short term small fluctuations of the bandwidth.

In the illustrated embodiment, if either one of the two checks at block 406 indicate that a switch to a representation with lower bandwidth level is required, the process proceeds to block 408, and the client switches to a new representation with a bandwidth level lower than the current bandwidth level. In one embodiment, the client might switch to a significantly a new representation with a significantly lower bandwidth level, compared to the current bandwidth level, to perform a fast fill up of the buffer. In other embodiments, the client may switch to the representation with the next, or closest, lower bandwidth level compared to the current bandwidth level. The process then proceeds to block 414 to fetch the next media segment.

In one embodiment, once the decision to switch down is taken, the target representation is then chosen so that it requires lower bandwidth than the currently estimated available bandwidth. In one embodiment, the target bandwidth is calculated based on the measured FTDR value as follows:

$$B {W}_{target} < \frac{B {W}_{current}}{F T D R}$$

Based on this calculation, a representation level satisfying the BW_{target} requirement is selected.

Returning to block 406, in the illustrated embodiment, if neither of the two checks indicates that a switch in representation, to a lower bandwidth level, is to be made, the process proceeds to block 410 to determine if a switch to representation with higher bandwidth level is to be made. At block 410, two checks are performed for this determination.

The first check relates to the FTDR metric. In this regard, the FTDR is checked against a threshold value, th_{up switch}, set for switching to a representation with higher bandwidth level compared to the current bandwidth level. If the calculated FTDR metric is below the lower bound th_{upswitch}, then the first condition for switching to a representation with higher bandwidth level is satisfied.

The second check at block 410 for switching to a higher representation is to ensure that sufficient buffer exists to cover for the case that the available bandwidth drops from the level of the bandwidth of the target representation down to the bandwidth of the lowest available representation. In the equations below, BWₘᵢₙ represents the bandwidth of the lowest representation, and BW_{target} represents the bandwidth of the target representation to which the client may switch.

In accordance with an example embodiment, the current buffer level BTᵢ must satisfy the following constraint:

$$B {T}_{i} > ( \frac{B {W}_{target}}{B {W}_{min - 1}} ) \times {SD}_{target} + minBufferTime$$

where: SD_{target} is the segment duration of the target representation; and

minBufferTime is the required minimum buffering time before playback starts.

The minBufferTime represents the minimum level for the client buffer expressed in terms of corresponding playback time. The term

$$( \frac{{BW}_{target}}{{BW}_{min - 1}} ) \times {SD}_{target}$$

represents the time duration during which additional amount of media data is consumed from the client buffer, in case the bandwidth drops from BW_{target} to BWₘᵢₙ immediately after requesting a media segment from representation with bandwidth BW_{target}. This time duration also corresponds to the additional time that it takes to finish downloading the media segment at the lowest bandwidth.

If the current buffer level BTᵢ satisfies this constraint, it ensures that during the fetching of a segment from the target representation and in the worst case of the bandwidth dropping down to the lowest bandwidth supported, the client will have sufficiently buffered media to finish the reception of the current media segment before switching to a different representation without playback interruption.

Thus, if both checks at block 410 are satisfied, the process proceeds to block 412, and the client switches to a higher representation. The process then proceeds to block 414, and the client fetches the next media segment.

If either one or both of the checks at block 410 are not satisfied, the process proceeds to block 414 without switching representation, and the client fetches the next media segment. In some embodiments, the higher representation level may be selected even if only one of the checks at block 410 is satisfied.

Those skilled in the art will recognize that variations of the process of FIG. 4 are possible and are contemplated within the scope of the present invention. For example, in one embodiment, the determination illustrated at block 410 may be performed first to determine whether a switch to a representation with a higher bandwidth level is to be made. If not, then the determination at block 406 may be performed to determine if a switch to a representation with a lower bandwidth level is to be made.

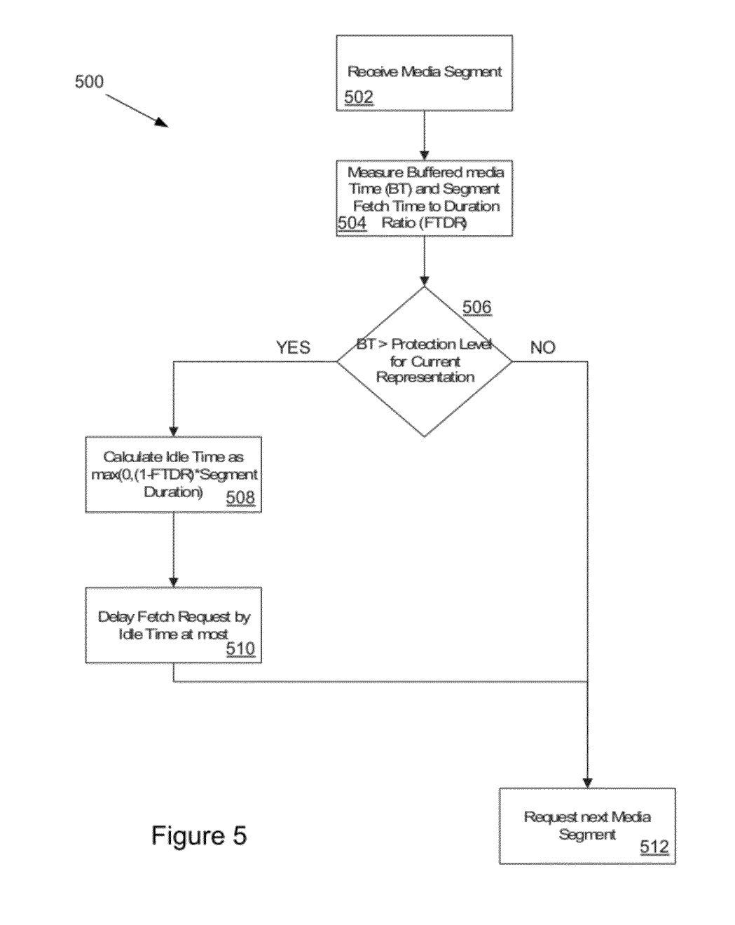

Further embodiments of the present invention may allow for a reduction in the amount of advance download, thereby reducing the size of the buffer at the client. Referring now to FIG. 5, a flow chart illustrates a process 500 in accordance with an example embodiment of the present invention. At block 502, the client receives a media segment as described above. At block 504, the client calculates the BT and FTDR metrics.

At block 506, a determination is made as to whether BT is greater than the protection level, or buffer threshold, for the current representation. In one embodiment, the determination is made according to the following calculation:

$$B {T}_{i} > ( \frac{B {W}_{current}}{B {W}_{min - 1}} ) \times {SD}_{current} + minBufferTime$$

As noted above, the protection level ensures that in case of a sudden drop in bandwidth down to the lowest available bandwidth, bandwidth of the lowest representation, no buffer underflow and by consequence playback interruptions will happen.

Once this condition is reached, the client considers the session to be in a stable state, and it will be able to cope with sudden and significant drops in the available bandwidth.

In accordance with the above calculation, if BT is determined to be not greater than the threshold value, the process proceeds to block 512 and continues by requesting the next media segment.

On the other hand, if the determination is made at block 506 that BT is greater than the threshold value, the process proceeds to block 508, where an idle time is calculated. The idle time represents the time between the reception of the last byte of a media segment and that of sending the HTTP request for the next media segment. This time plays an important role in reducing the amount of advance download and by consequence also the size of the buffer at the client. By doing this, the algorithm keeps the bandwidth consumption at a good level especially in the case where the user is zapping between content pieces.

The idle time may be determined as follows:

Idle Time=max(0,SD_{current-}last Segment Fetch Duration)

Thus, idle time is the difference between the segment duration and the time it took to fetch the previous segment.

At block 510, the fetch request for the next media segment is delayed by an amount no greater than the calculated idle time. In an example embodiment, the entire idle time may be used, while in other embodiments, a certain percentage of the idle time may be used. Still in another example embodiment, all but a certain amount of idle time may be used. Upon expiration of the delay, the process proceeds to block 512 and request the next media segment.

It will be understood by those skilled in the art that the processes of FIGS. 4 and 5 may be implemented independently of one another. For example, it is possible that, in certain example embodiments, both processes of FIGS. 4 and 5 are implemented by, for example, performing the process of FIG. 5 as an initial step of block 414 of FIG. 4. In another example, the process of FIG. 5 is performed within the process of FIG. 4, specifically in the case where a decision not to switch to a different representation is made.

Embodiments of the rate control algorithms described herein may significantly reduce the probability of playback interruptions due to buffer underflow. Further, they reduce the buffering delay and control the amount of advance download of media data during an AHS session.

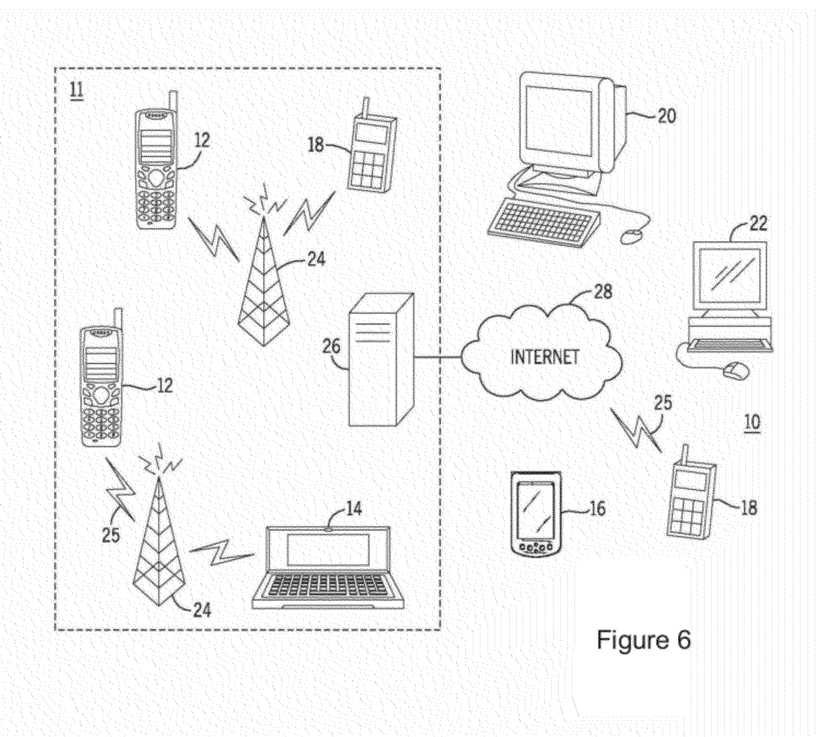

FIG. 6 shows a system 10 in which various embodiments of the present invention can be utilized, comprising multiple communication devices that can communicate through one or more networks. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 6 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, an electronic device 12 in the form of a mobile telephone, a combination personal digital assistant (PDA) and mobile telephone 14, a PDA 16, an integrated messaging device (IMD) 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like.

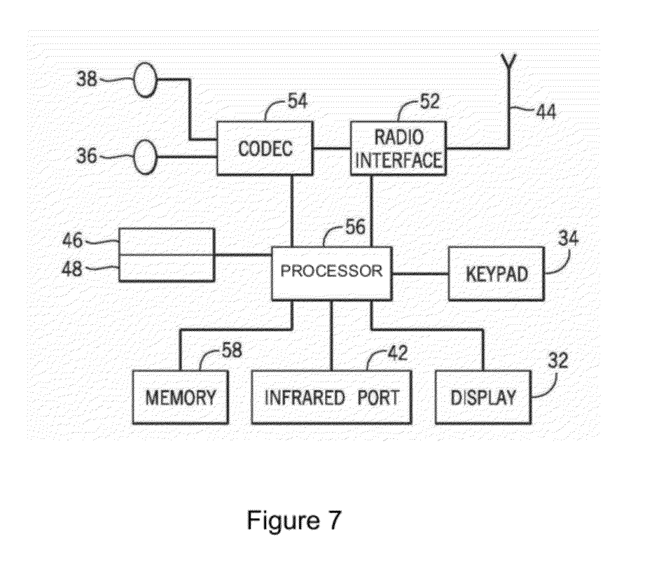

FIG. 7 shows one representative electronic device which may be used in accordance to the various embodiments of the present invention. In embodiments of the present invention, the device of FIG. 7 may be representative of a client device, a streaming server or a network device. It should be understood, however, that the scope of the present invention is not intended to be limited to one particular type of device. The electronic device of FIG. 7 may includes a housing, a display in the form of a liquid crystal display, a keypad 34, a microphone 36, an ear-piece 38, a battery, an infrared port 42, an antenna 44, a smart card 46 in the form of a UICC according to one embodiment, a card reader 48, radio interface circuitry 52, codec circuitry 54, one or more processors, such as processor 56, and one or more memories, such as memory 58. The above described components enable the electronic device to send/receive various messages to/from other devices that may reside on a network in accordance with the various embodiments of the present invention. Individual circuits and elements are all of a type well known in the art, for example in the Nokia range of mobile telephones.

Various embodiments described herein are described in the general context of method steps or processes, which may be implemented in one embodiment by a computer program product, embodied in a computer-readable memory, including computer-executable instructions, such as program code, executed by computers in networked environments. A computer-readable memory may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes. Various embodiments may comprise a computer-readable medium including computer executable instructions which, when executed by a processor, cause an apparatus to perform the methods and processes described herein.

Embodiments of the present invention may be implemented in software, hardware, application logic or a combination of software, hardware and application logic. The software, application logic and/or hardware may reside on a client device, a server or a network component. If desired, part of the software, application logic and/or hardware may reside on a client device, part of the software, application logic and/or hardware may reside on a server, and part of the software, application logic and/or hardware may reside on a network component. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 7. A computer-readable medium may comprise a computer-readable storage medium that may be any media or means that can contain or store the instructions for use by or in connection with an instruction execution system, apparatus, or device, such as a computer. In one embodiment, the computer-readable storage medium is a non-transitory storage medium.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. A method, comprising:
performing one or more checks associated with hyper text transport protocol streaming of segmented media data, the segmented media data being streamed at a current bandwidth level corresponding to current representation of the content;
deciding, based on the results of the one or more checks, whether or not to switch to another representation associated with another bandwidth level different from said current bandwidth level; and
upon deciding to switch to another representation,
selecting a new representation with a bandwidth level different from said current bandwidth level; and
requesting a next media segment from the new representation.

2. The method of claim 1, wherein the one or more checks comprise:
determining whether an amount of currently buffered media is less than a buffer threshold associated with the current representation; and
determining whether a segment fetch time to segment duration ratio is greater than an upper threshold associated with the segment fetch time to segment duration ratio.

3. The method of claim 2, wherein the selecting of a new representation comprises selecting a new representation with a bandwidth level lower than the current bandwidth level if:
the amount of currently buffered media is less than the buffer threshold associated with the current representation, or
the segment fetch time to segment duration ratio is greater than the upper threshold associated with the fetch time to segment duration ratio.

4. The method of claim 2, wherein the upper threshold associated with the segment fetch time to segment duration ratio is greater than 1.

5. The method of claim 1, wherein the one or more checks comprise:
determining whether an amount of currently buffered media is greater than a buffer threshold associated with another representation, said another representation being associated with a bandwidth level higher than the current bandwidth level; and
determining whether a segment fetch time to segment duration ratio is less than a lower threshold associated with the segment fetch time to segment duration ratio.

6. The method of claim 5, wherein the selecting of a new representation comprises selecting a representation with a bandwidth level higher than the current bandwidth level if:
the amount of currently buffered media is greater than the buffer threshold associated with said another representation, or
the segment fetch time to segment duration ratio is less than the lower threshold associated with the segment fetch time to segment duration ratio.

7. The method of claim 6, wherein said new representation with a bandwidth level higher than the current bandwidth comprises a representation with the closest higher bandwidth level compared to the current bandwidth level.

8. The method of claim 5, wherein the lower threshold associated with the segment fetch time to segment duration ratio is less than 1.

9. The method of claim 1, wherein upon deciding not to switch to another representation:
delaying requesting a next media segment from the current representation upon determination that an amount of currently buffered media is greater than a buffer threshold associated with the current representation.

10. The method of claim 9, wherein the requesting of a next media segment is delayed by an amount of time that is no greater than an idle time calculated based on a segment fetch time to segment duration ratio.

11. An apparatus, comprising:
at least one processor; and
at least one memory including computer program code, the at least one memory and the computer program code configured to, with the at least one processor, cause the apparatus to perform at least the following:
perform one or more checks associated with hyper text transport protocol streaming of segmented media data, the segmented media data being streamed at a current bandwidth level corresponding to current representation of the content;
decide, based on the results of the one or more checks, whether or not to switch to another representation associated with another bandwidth level different from said current bandwidth level; and
upon deciding to switch to another representation,
select a new representation with a bandwidth level different from said current bandwidth level; and
request a next media segment from the new representation.

12. The apparatus of claim 11, wherein the one or more checks comprise:
determining whether an amount of currently buffered media is less than a buffer threshold associated with the current representation; and
determining whether a segment fetch time to segment duration ratio is greater than an upper threshold associated with the segment fetch time to segment duration ratio.

13. The apparatus of claim 12, wherein the selecting of a new representation comprises selecting a new representation with a bandwidth level lower than the current bandwidth level if:
the amount of currently buffered media is less than the buffer threshold associated with the current representation, or
the segment fetch time to segment duration ratio is greater than the upper threshold associated with the fetch time to segment duration ratio.

14. The apparatus of claim 12, wherein the upper threshold associated with the segment fetch time to segment duration ratio is greater than 1.

15. The apparatus of claim 11, wherein the one or more checks comprise:
determining whether an amount of currently buffered media is greater than a buffer threshold associated with another representation, said another representation being associated with a bandwidth level higher than the current bandwidth level; and
determining whether a segment fetch time to segment duration ratio is less than a lower threshold associated with the segment fetch time to segment duration ratio.

16. The apparatus of claim 15, wherein the selecting of a new representation comprises selecting a representation with a bandwidth level higher than the current bandwidth level if:
the amount of currently buffered media is greater than the buffer threshold associated with said another representation, or
the segment fetch time to segment duration ratio is less than the lower threshold associated with the segment fetch time to segment duration ratio.

17. The apparatus of claim 16, wherein said new representation with a bandwidth level higher than the current bandwidth comprises a representation with the closest higher bandwidth level compared to the current bandwidth level.

18. The apparatus of claim 15, wherein the lower threshold associated with the segment fetch time to segment duration ratio is less than 1.

19. The apparatus of claim 11, wherein upon deciding not to switch to another representation:
delaying requesting a next media segment from the current representation upon determination that an amount of currently buffered media is greater than a buffer threshold associated with the current representation.

20. The apparatus of claim 19, wherein the requesting of a next media segment is delayed by an amount of time that is no greater than an idle time calculated based on a segment fetch time to segment duration ratio.

21. A computer-readable medium including computer executable instructions which, when executed by a processor, cause an apparatus to perform at least the following:
perform one or more checks associated with hyper text transport protocol streaming of segmented media data, the segmented media data being streamed at a current bandwidth level corresponding to current representation of the content;
decide, based on the results of the one or more checks, whether or not to switch to another representation associated with another bandwidth level different from said current bandwidth level; and
upon deciding to switch to another representation,
select a new representation with a bandwidth level different from said current bandwidth level; and
request a next media segment from the new representation.
